(19) United States
(12) Patent Application Publication
(10) Pub. No.: US 2016/0300171 A1
(43) Pub. Date: Oct. 13, 2016

(54) RISK-BASED ORDER MANAGEMENT WITH HETEROGENEOUS VARIABLES IN A CONSTRAINED ENVIRONMENT

(71) Applicant: International Business Machines Corporation, Armonk, NY (US)

(72) Inventors: Warren Boldrin, Montgomery, NY (US); Christiana M. Drayer, Poughkeepsie, NY (US); Sreekanth Ramakrishnan, Salem, MA (US); Chanchal Saha, Poughkeepsie, NY (US)

(73) Assignee: International Business Machines Corporation, Armonk, NY (US)

(21) Appl. No.: 14/682,322

(22) Filed: Apr. 9, 2015

(51) Int. Cl. G06Q 10/06; G06Q 50/28

(52) U.S. Cl. CPC G06Q 10/06315; G06Q 10/0635; G06Q 50/28

(57) ABSTRACT

A set of channel inputs corresponding to an order is received. A subset of the set is transformed, using a transformation rule, into a set of strategic transformed inputs. A total impact value and an integrated risk likelihood value corresponding to the order are computed. The integrated risk likelihood value and the total impact value of the order are output, to a shipping system, relative to a second integrated risk likelihood value and a second total impact value of a second completed order from a second channel, as a comparison of a first risk associated with the completed order relative to a second risk associated with the second completed order at a shipping dock. The shipping dock is shared by the order processing channel and the second order processing channel. When the first risk being higher than the second risk, the order is selected for shipping using the shipping system.

### TECHNICAL FIELD

The present invention relates generally to a method, system, and computer program product for managing delivery of completed or in-progress orders. More particularly, the present invention relates to a method, system, and computer program product for risk mitigation and order ranking in a shared capacity constrained shipping process.

### BACKGROUND

A typical supply chain spans numerous different entities, and involves flow of significant volume and types of products in a systematic and timely manner. Supply chain management encompasses the planning and management of activities involved in sourcing and procurement, conversion, and logistics related management activities.

Supply chain management integrates supply and demand management within and across companies. For example, a manufacturing operation may include numerous business channels (also referred to herein as simply, “channel” or “channels”). Supply chain management also includes coordination and collaboration with customers as well as channel partners. Channel partners can be suppliers, intermediaries, third-party providers, and even other collaborating manufacturers.

Delivery management functions in supply chain management include, among other functions, preparing completed or in-progress orders for delivery and managing the logistics of delivery operations. For example, completed or in-progress orders arrive at a shipping dock or location for shipment to the various customers. Operations from receiving the completed or in-progress orders into shipping, and up to their delivery at the final destination, come within the purview of delivery management functions.

Various channels may be producing a variety of products for fulfilling customer orders. An order may include products produced in one or more channels. The products that are output from one or more channels, and which can be shipped in satisfaction of all or a part of an order, are regarded as a completed or in-progress order.

### SUMMARY

The illustrative embodiments provide a method, system, and computer program product for shipping orders from various manufacturing channels using a shared capacity constrained shipping process for the orders prioritized within a business channel. An embodiment includes a method for risk mitigation in a shared shipping process. The embodiment receives, from an order processing channel, a set of channel inputs corresponding to an order. The embodiment transforms, using a processor and a memory, and using a transformation rule, a strategic subset of the set of the channel inputs, forming a set of strategic transformed inputs. The embodiment computes a total impact value corresponding to the order. The embodiment computes an integrated risk likelihood value corresponding to the order. The embodiment outputs to a shipping system the integrated risk likelihood value and the total impact value of the order relative to a second integrated risk likelihood value and a second total impact value of a second order from a second order processing channel, as a comparison of a first risk associated with the order relative to a second risk associated with the second order at a shipping dock, where the shipping dock is shared by the order processing channel and the second order processing channel. The embodiment, using the shipping system, ships the order responsive to the first risk being higher than the second risk.

Another embodiment includes a computer readable article of manufacture tangibly embodying computer readable instructions which, when executed, cause a computer to carry out steps of a method for shipping orders from various manufacturing channels using a shared shipping process.

Another embodiment includes a data processing system for shipping orders from various manufacturing channels using a shared shipping process.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3A depicts a block diagram of an example process for risk mitigation in a shared shipping process for prioritized orders in accordance with an illustrative embodiment;

FIG. 3B depicts example tables for use with input transformation rules in accordance with an illustrative embodiment;

FIG. 4 depicts an example representation of the inputs, the transformations, and the graph presented in accordance with an illustrative embodiment;

FIG. 5 depicts an example user interface presentation of risk mitigation graph and list of orders with details in a shared shipping process in accordance with an illustrative embodiment; and

FIG. 6 depicts a flowchart of an example process for risk mitigation in a shared shipping process in accordance with an illustrative embodiment.

### DETAILED DESCRIPTION

Handling multiple diverse channels in a competitive and satisfactory manner is challenging. Additional challenges arise when multiple channels share common resources. A shipping facility, location, or dock (collectively and interchangeably referred to herein as a “shipping dock”) is an example of a shared resource.

Many companies are morphing from a traditional new build, single brand, silo environment, to facilities that can accommodate diverse missions of new, used, cross brand solutions, and customer solutions. At the operational level, the success factors for such businesses translate into effective order management, supply allocation, and resource utilization.

At the strategic level, operating a plurality of channels to accommodate diverse missions has risks. These risks include costs of duplicate resources instead of sharing a resource—such as a shipping dock, cost of penalties due to delivery delays from using shared resources, and the like.

Thus, the illustrative embodiments recognize that where multiple business channels share the shipping docks and other similar delivery resources, the manufacturers have to pay greater attention to risk mitigation by ensuring costs, quality, and on-time delivery of completed or in-progress orders. The illustrative embodiments recognize that improved utilization of shared delivery resources is one way of mitigating risk in such a production environment.

The illustrative embodiments used to describe the invention generally address and solve the above-described problems and other problems related to managing shared shipping dock in a manufacturing environment. The illustrative embodiments provide a method, system, and computer program product for risk mitigation in a shared shipping process for prioritized orders. In other words, the illustrative embodiments facilitate a manner of using a shared shipping process, which is used to ship prioritized orders, such that risk arising from shipping related delays are mitigated.

An embodiment can be implemented as an application in software, hardware, or firmware, to operate in conjunction with a supply chain management system, such as with a delivery or shipping component of a supply chain management system. Some operations of some embodiments described herein can be implemented in a component of a supply chain management system, such as by modifying a shipping component of a supply chain management system to perform those operations. Generally, within the scope of the illustrative embodiments, the operations and functions of an embodiment can be implemented in a stand-alone manner or in conjunction with other applications executing in the supply chain management system.

An embodiment provides efficient management and fulfillment of customer orders from multiple business channels, which share a common resource at the final stage of their order fulfillment process. The embodiment integrates information from an order prioritization tool (OPT) and an order fulfillment progress projection tool, to provide the risk mitigation features described herein.

The embodiment accepts from one or more channel systems inputs (heterogeneous variables) representing strategic decision inputs from the channel. Some non-limiting examples of such inputs are revenue from a completed or in-progress order, a type or category of customer who placed the order, and a business channel identifier from where the completed or in-progress order is coming into shipping.

The embodiment transforms the strategic inputs from the channels to produce one set of order-specific information (hereinafter referred to as strategic “transformed input”). Some non-limiting examples of a strategic transformed input are a revenue score between 0 and 1, a customer urgency score between 0 and 1, and a sales impact score between 0 and 1.

The embodiment selects weights from a weight matrix and assigns the selected weights to the strategic transformed inputs. Using the strategic transformed inputs and the corresponding weights, an embodiment computes a total impact value (TI). In one embodiment, the total of all weights assigned to all strategic transformed inputs equals 1.

An embodiment configures or tunes the weight matrix based on the present needs of the manufacturing environment. For example, it may be that at the beginning of a fiscal quarter, the sales impact of dissatisfied customers due to delayed deliveries is a more important consideration than the revenue advantage of delaying a delivery. Accordingly, at the beginning of a quarter, the embodiment assigns a higher weight to the sales impact score transformed input than a weight assigned to the revenue score transformed input.

Likewise, in another example, it may be that at the end of a fiscal quarter, the revenue advantage of delaying a delivery is a more important consideration than the sales impact of dissatisfied customers due to delayed deliveries. Accordingly, at the end of a quarter, the embodiment assigns a higher weight to the revenue score transformed input as compared to a weight assigned to the sales impact score transformed input.

The weights in the weight matrix are tuned according to these and other similarly purposed considerations. For example, an embodiment adjusts a weight in the matrix based upon a special request from a manager, or an unusual condition.

The embodiment accepts from one or more channel systems inputs representing operational inputs from the channel. Some non-limiting examples of such inputs are transportation mode to be used for a completed or in-progress order, a weather forecast for the duration of the shipping, a number of hops or cross-docks that the shipment is expected to pass through, and a rank of the order within the channel.

The embodiment transforms the operational inputs from the channels to produce another set of order-specific information, to wit, a set of operational transformed input. Some non-limiting examples of an operational transformed input are a transportation delay probability, and an order priority index, e.g., a “Technique for Order of Preference by Similarity to Ideal Solution” (TOPSIS) order priority index.

The transportation delay probability that an order will be delayed in reaching its destination. The order priority index of an order is a score between 0 and 1 that is calculated using the order ranking of that order obtained from its respective business channel, shipping dock capacity, and resistance value of the workers working at the shipping dock.

In transforming the operational inputs from the channels, the embodiment uses inputs from the shipping dock as well. For example, the embodiment receives a shipping capacity input and a resistance input from a system that manages the shared shipping dock. The shipping capacity is indicative of a number of orders that can be shipped during a period from the shipping dock. Resistance is a quantification of variability in the dock-workers' shipping capacity during a given period. For example, it is often observed that workers' capacity to complete a job is flexible rather than a constant shipping capacity number. Workers can ship more than the actual shipping capacity depending on their skill levels. Lower values of resistance means higher flexibility and more skilled workers, and vice versa.

Using the operational transformed inputs and the corresponding weights, an embodiment computes an integrated risk likelihood (IRL). The TI and the IRL are order-specific. In other words, the embodiment computes a TI and an IRL for each order that is awaiting shipment at the shared shipping dock.

A risk mitigation tool implements one or more embodiments described herein. Using the IRL (X-axis) and the TI (Y-axis) values for a set of orders awaiting shipment during a given period, the risk mitigation tool plots a graph. The graph has regions defined to separate categories of orders. These regions are referred to hereinafter as risk regions or risk zones. A category of an order includes a range of (IRL, TI) coordinates. Any number of ranges can be defined within the scope of the illustrative embodiments to create any number of corresponding categories of orders for shipment.

For example one risk zone may be labeled “Very High Priority” and may correspond to an area above a curve defined by y=a[ê(−x)]+b, where ê(−x) is an example inverse exponential function. Another risk zone may be labeled “High Priority” and may correspond to an area above a curve defined by y=g[ê(−x)]+h and below the curve of y=a[ê(−x)]+b. Another risk zone may be labeled “Medium Priority” and may correspond to an area above a curve defined by y=j[ê(−x)]+k and below the curve of y=g[ê(−x)]+h. Any number of risk zone, defined by any type of curve, not limited to the curves of the example equations shown here, can similarly be defined.

Depending on where the (IRL, TI) point corresponding to an order is plotted on the graph, the risk mitigation tool ascertains the risk associated with that order. The higher the IRL and TI values from an order, the higher risk is associated with that order. Because the IRL and the TI values of the order account for factors that contribute to the risk from the delay in shipping that order, the shipping priority determined for the order based on the order's (IRL, TI) coordinates eliminates, minimizes, reduces, compensates, or otherwise mitigates the risk from a delay in shipping of that order.

Once the (IRL, TI) coordinates of all orders awaiting shipment during a period are plotted relative to the defined shipping priority regions—or risk zone, the risk mitigation tool can select, or can allow a user to select, the orders for shipment according to the shipping capacity during a time period and locations of the coordinates of the orders during that period in the risk mitigation graph. For example, a shipping personnel can use a user interface, which is presented from the risk mitigation tool according to an embodiment, to select a number of orders according to the location of the orders' coordinates in the risk mitigation graph and the available shipping capacity during a period.

A method of an embodiment described herein, when implemented to execute on a device or data processing system, comprises substantial advancement of the functionality of that device or data processing system in risk mitigation in a shared shipping process for prioritized orders. For example, the prior-art either employs duplicate shipping dock resources, or requires modifications to business channels sharing a shipping dock shared resource, or plans shipments based on statistical analysis of historical data, to manage risk from shipping delays. In contrast, an embodiment considers that every order comprises a certain amount of risk from both overall business' point of view as well as from an individual channel's point of view. An embodiment transforms the channel data and shared resource data into two risk scores corresponding to an order. The embodiment then plots the two risk scores in a two dimensional chart that is divided into several risk regions or risk zones to identify a relative overall risk for that particular order amongst the orders pending shipment during a given period. Such manner of order shipment planning using a shared shipping dock resource is unavailable in presently available devices or data processing systems. Thus, a substantial advancement of such devices or data processing systems by executing a method of an embodiment mitigates risks from delayed shipments while accounting for the dynamic conditions in the channels and the shipping dock, and without altering the workflow in either the channels or the shipping docks.

The illustrative embodiments are described with respect to certain tools, values, graphs, probabilities, inputs, transformations, weights, conditions, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

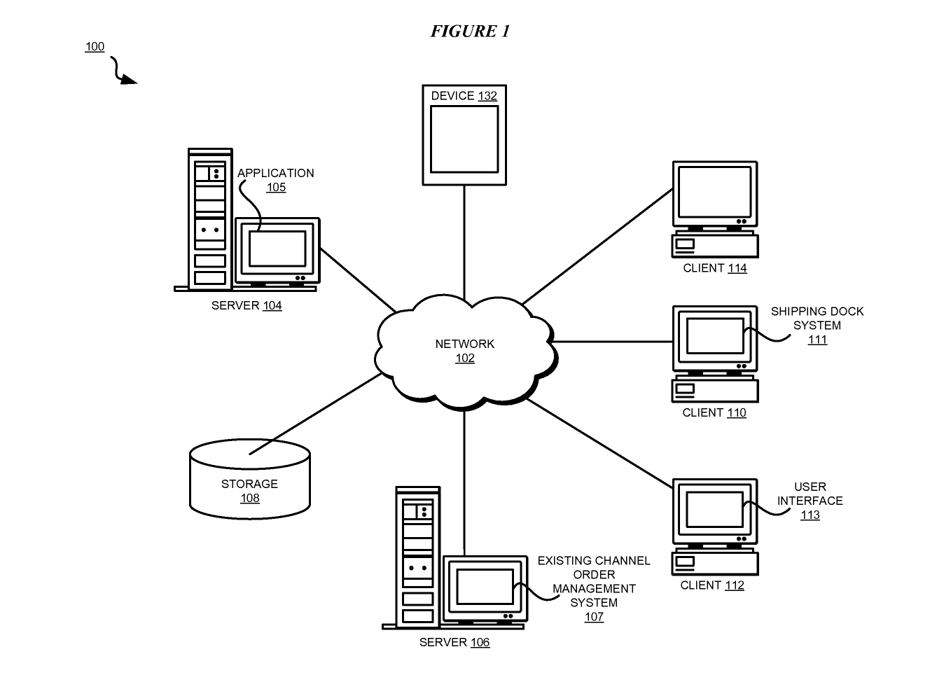

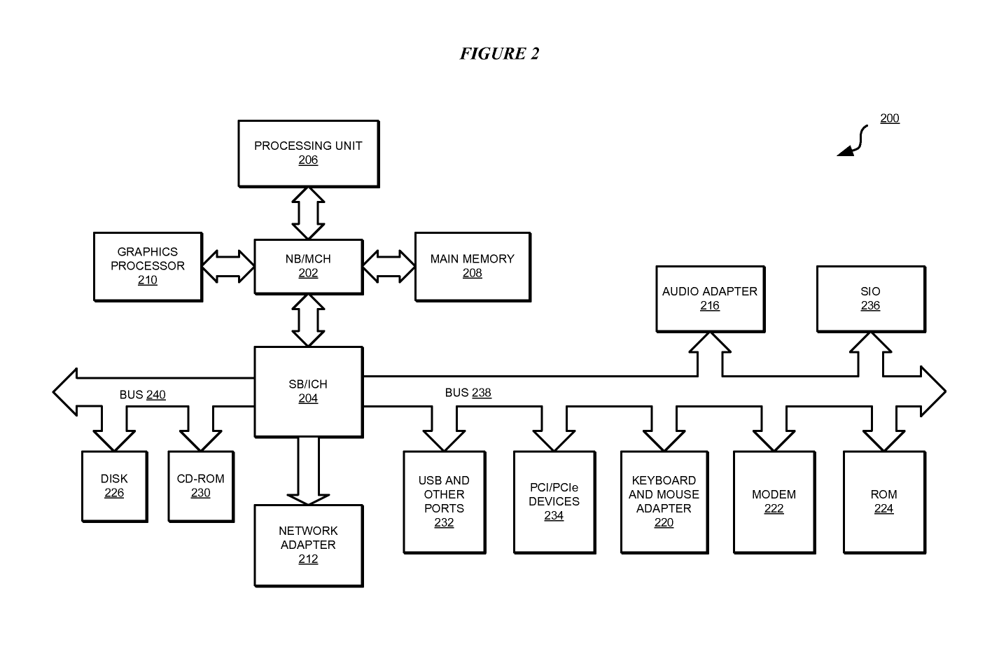

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner. Application 105 implements an embodiment described herein. Existing channel order management system is a component of a supply chain management system to manage the orders in a channel, and provides strategic and operational inputs to application 105. Shipping docks system 111 is another component of a supply chain management system to manage the deliveries and shipment of completed or in-progress orders, and provides dynamic dock condition inputs to application 105 as described herein. User interface 113 is presented from application 105, and allows a user to receive a graph and/or a listing of orders awaiting shipment during a given period. User interface 113 shows the user the shipping priorities of the orders relative to one another and relative to pre-defined risk zones.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

Data processing system 200 is also representative of a data processing system or a configuration therein, such as device 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive or solid-state drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as hard disk drive 226 or a solid-state data storage device, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a mobile computing device, which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device. For example, data processing system 200 can be a handheld device used by mobile shipping dock personnel to track the movement of orders at the shipping dock.

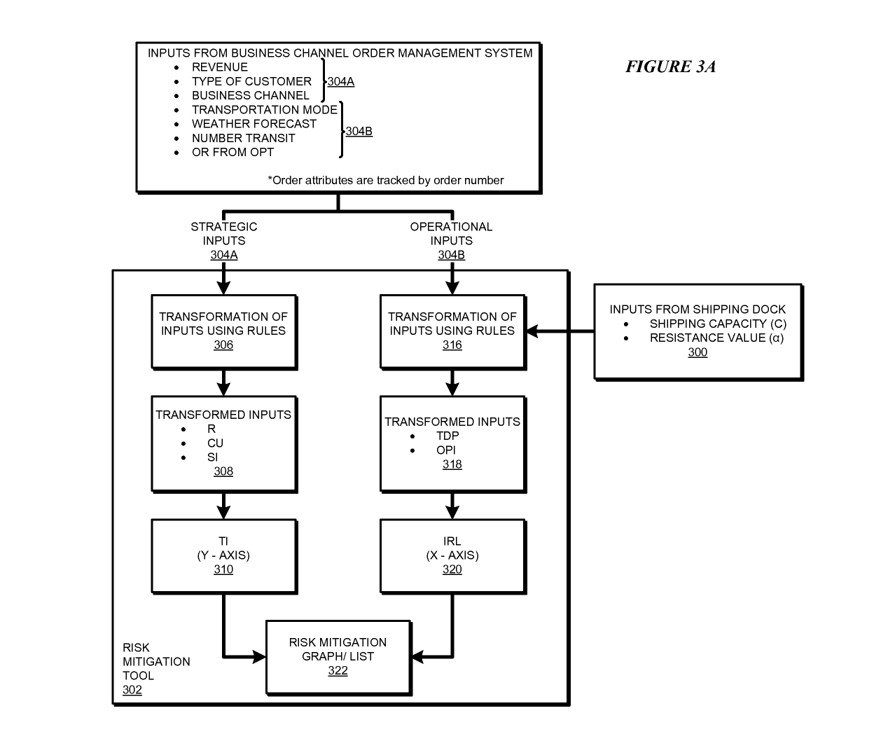

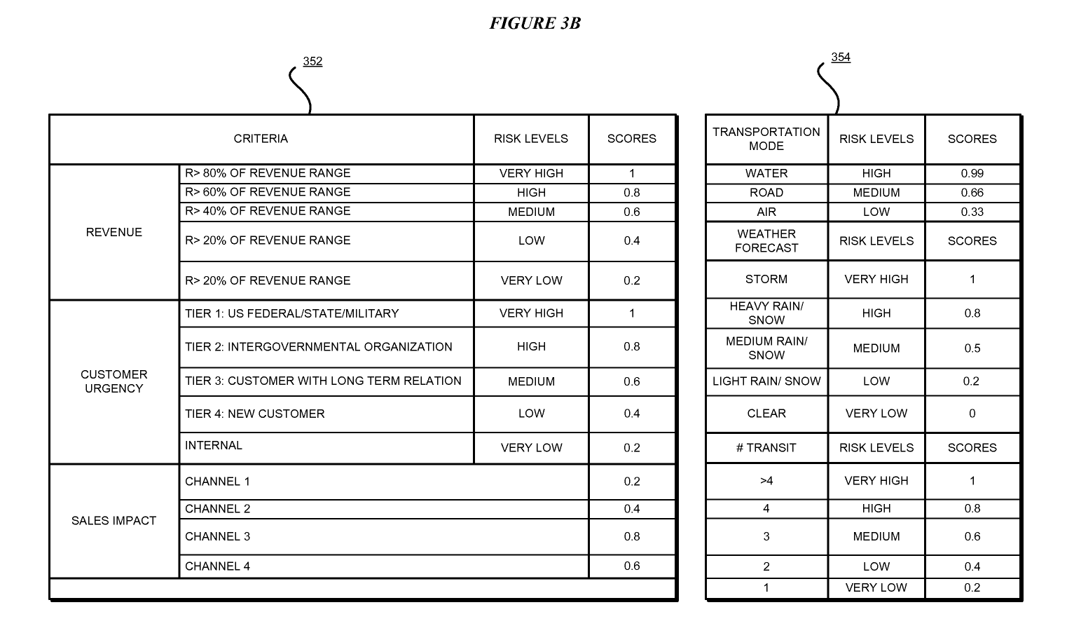

With reference to FIG. 3A, this figure depicts a block diagram of an example process for risk mitigation in a shared shipping process for prioritized orders in accordance with an illustrative embodiment. Risk mitigation tool 302 is an example of application 105 in FIG. 1 and implements an embodiment described herein.

For each order coming from a channel into a shared shipping dock, a business channel order management system, such as system 107 in FIG. 1, provides inputs 304. Particularly, according to an embodiment, inputs 304 include strategic inputs 304A and operational inputs 304B.

As described elsewhere in this disclosure, strategic inputs 304A include revenue from the order, type of customer who placed the order, and an identifier of the business channel that is processing the order. Also as described elsewhere in this disclosure, operational inputs 304B include the transportation mode selected for delivering the order, a weather forecast for the period during which the shipping and delivery is to occur, number of transits or hops the order is expected to make between the shipping dock and the destination, and a ranking of the order in the order's individual channel.

Component 306 transforms strategic inputs 304A using one or more transformation rules. For example, table 352 in FIG. 3B shows that different revenue ranges have different risk levels and therefore different corresponding scores between 0 and 1 associated therewith. A rule logic determines the score for strategic transformed input “revenue” (R) by determining the score associated with the revenue range in which input 304A corresponding to the revenue from the order falls.

Similarly, different types of customers from input 304A translate into different customer urgency (CU) in strategic transformed input. For example, table 352 in FIG. 3B shows that different customer types have different risk levels and therefore different corresponding scores between 0 and 1 associated therewith. A rule logic determines the score for strategic transformed input CU by determining the score associated with the type of customer in input 304A.

Similarly, different channels from input 304A translate into different sales impact (SI) in strategic transformed input. For example, table 352 in FIG. 3B shows that different channels have different scores between 0 and 1 associated therewith. A rule logic determines the score for strategic transformed input SI by determining the score associated with the channel in input 304A.

Thus, through application of one or more rules, and using table 352 or other similarly purposed information, risk mitigation tool 302 produces strategic transformed inputs 308. R, CU, and SI computed in the example manner above form an example set of strategic transformed inputs 308. These examples of strategic transformed inputs are not intended to be limiting. From this disclosure, those of ordinary skill in the art will be able to conceive many other strategic transformed inputs that are usable in a similar environment, and the same are contemplated within the scope of the illustrative embodiments.

Component 310 computes TI from strategic transformed inputs 308. In one example embodiment, a pre-configured weight matrix provides weights that can be associated with R, CU, and SI in computing TI. For example,

TI=100*(w₁*R+w₂*CU+w₃*SI)/(w₁+w₂+w₃);

w₁+w₂+w₃=1

where w₁, w₂, and w₃ are weights from a weight matrix

$$[ \begin{matrix}0 & {a}_{12} & … & {a}_{1 n} \\ 1 - {a}_{12} & 0 & … & {a}_{2 n} \\ ⋮ & ⋮ & ⋱ & ⋮ \\ 1 - {a}_{1 n} & 1 - {a}_{2 n} & … & 0\end{matrix} ] = [ \begin{matrix}0 & {b}_{12} & … & {b}_{1 n} \\ {b}_{21} & 0 & … & {b}_{2 n} \\ ⋮ & ⋮ & ⋱ & ⋮ \\ {b}_{n 1} & {b}_{n 2} & … & 0\end{matrix} ]$$

$$Where$$

$${a}_{ij} + {a}_{ji} = 1 and 0 < {a}_{ij} < 1$$

$$And$$

$${w}_{i} = \frac{{\sum }_{j = 1}^{n} {b}_{ij}}{( n \times ( ( n - 1 ) / 2 ) )}$$

The matrix [bᵢⱼ] can also be used to determine the weights or scores for the criteria shown in tables 352 and 354 in FIG. 3B.

In this example, only three weights w₁, w₂, and w₃ are used forming a 3×3 matrix only as a simplified example and without implying any limitations thereto. Additional strategic transformed inputs, e.g., for unusual circumstances described earlier, or other reasons, can similarly be added for a larger weight matrix. The weights in the matrix can be adjusted to cause different strategic transformed inputs to play roles of differing importance, such as during a beginning of a fiscal quarter and during an end of the fiscal quarter, as described in an example earlier.

Component 310 performs the computations in the manner described above and produces a TI value for an order. The TI value is plotted, for example, along the Y axis of risk mitigation graph 322. The right hand side of the TI equation is multiplied by 100 to produce a value between 0 and 100 for plotting purposes.

Component 316 transforms operational inputs 304B using one or more transformation rules in a similar manner. For example, table 354 in FIG. 3B shows that different transportation modes have different risk levels and therefore different corresponding scores between 0 and 1 associated therewith. A rule logic determines a part of the operational transformed input “transportation delay probability” (TDP) by determining the score associated with the transportation mode (TM) in input 304B.

Similarly, according to table 354 in FIG. 3B, different weather forecasts from input 304B translate into different risk levels, and therefore have different corresponding scores between 0 and 1 associated therewith. A rule logic determines another part of the operational transformed input TDP by determining the score associated with the type of weather forecast (WF) in input 304B.

Similarly, according to table 354 in FIG. 3B, different numbers of transits from input 304B translate into different risk levels, and therefore have different corresponding scores between 0 and 1 associated therewith. A rule logic determines another part of the operational transformed input TDP by determining the score associated with the number of transits (NT) in input 304B.

Thus, through application of one or more rules, and using table 354 in FIG. 3B or other similarly purposed information, risk mitigation tool 302 produces operational transformed input TDP 318. For example, component 316 computes TDP as follows—

TDP=(TM+WF+NT−(TM*WF)−(TM*NT)−(WF*NT)+(TM*WF*NT))

Component 316 further receives inputs 312 from the shipping dock system, such as from system 111 in FIG. 1. In one example embodiment, inputs 312 include shipping capacity C and resistance value a. In one example embodiment, using inputs 312 and order rank (OR) in inputs 304B, component 316 produces overall priority index (OPI) of operational transformed inputs 318 as follows—

OPI=Max(0,1−(α*OR/C))

Component 320 computes IRL from operational transformed inputs 318. In one example embodiment, component 320 computes,

IRL=(TDP+OPI−TDP*OPI)*100

The IRL value is plotted, for example, along the X axis of risk mitigation graph 322. The right hand side of the IRL equation is multiplied by 100 to produce a value between 0 and 100 for plotting purposes.

In one embodiment, graph 322 is output from risk mitigation tool 302 via a user interface (not shown). In another embodiment, a list (not shown) of orders from their respective channels awaiting shipping during a period is presented using the user interface (not shown). In another embodiment, graph 322 and the list of orders are both presented via the user interface (not shown).

With reference to FIG. 3B, this figure depicts example tables for use with input transformation rules in accordance with an illustrative embodiment. Tables 352 and 354 are used by risk mitigation tool 302 in FIG. 3A in the manner described with respect to FIG. 3A.

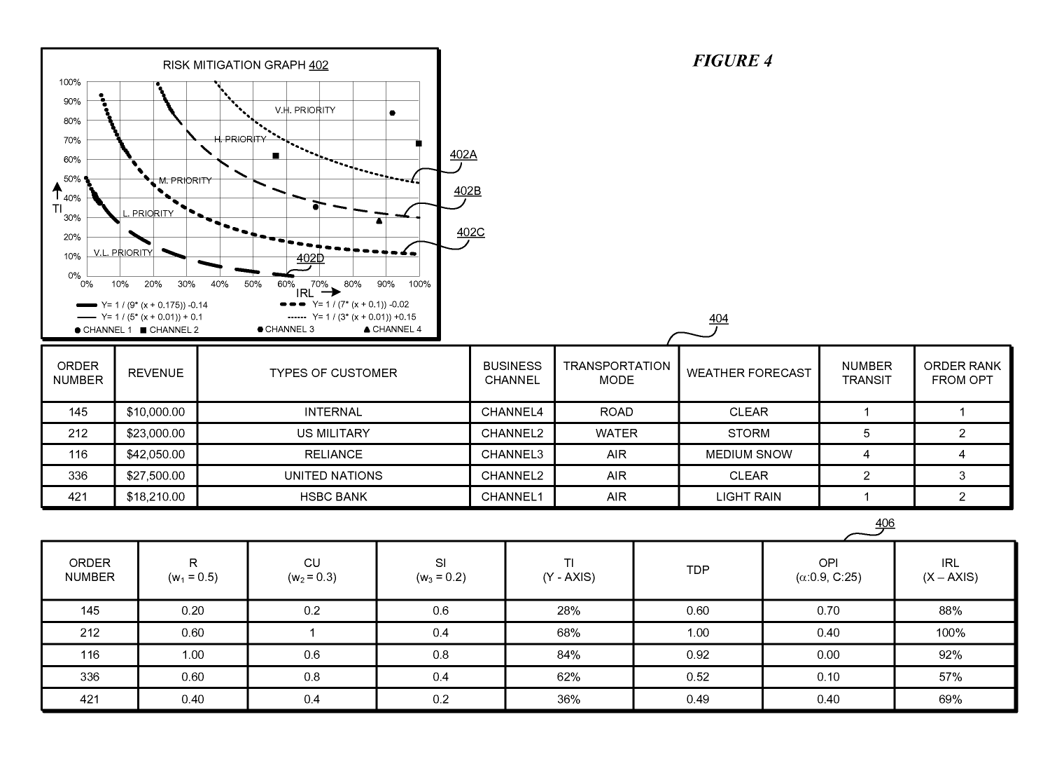

With reference to FIG. 4, this figure depicts an example representation of the inputs, the transformations, and the graph presented in accordance with an illustrative embodiment. Graph 402 is an example of graph 322 in FIG. 3A.

Curves 402A, 402B, 402C, and 402D are example curves bounding various example risk zones. (IRL, TI) coordinates corresponding to various orders are plotted relative to risk zones 402A-D as shown by some example plotted order coordinates.

Table 404 shows examples of inputs 304 in FIG. 3A. Each row in table 404 corresponds to a set of inputs 304 for one order that is to be shipped. For example, row data in columns “Revenue”, “type of customer” and “Business channel” form inputs 304A. Similarly, for example, row data in columns “Transportation mode”, “Weather forecast”, “Number transit”, and “order rank” form inputs 304B.

Table 406 shows the corresponding transformed inputs 308 and 318 in FIG. 3A. A row in table 406 corresponds to the same row in table 404.

For example, in table 406, the weight for R is set to 0.5, the weight for CU is set to 0.3, and the weight for SI is set to 0.2. Using these example weights, row data in columns “R”, “CU”, and “SI” corresponds to strategic transformed inputs 308 and is computed in the manner described with respect to component 306 in FIG. 3A. Data in the “TI” column is computed using this row data as described with respect to component 310 in FIG. 3A.

Similarly, row data in columns “TDP” and “OPI” corresponds to operational transformed inputs 318 and is computed in the manner described with respect to component 316 in FIG. 3A. Data in the “IRL” column is computed using this row data as described with respect to component 320 in FIG. 3A.

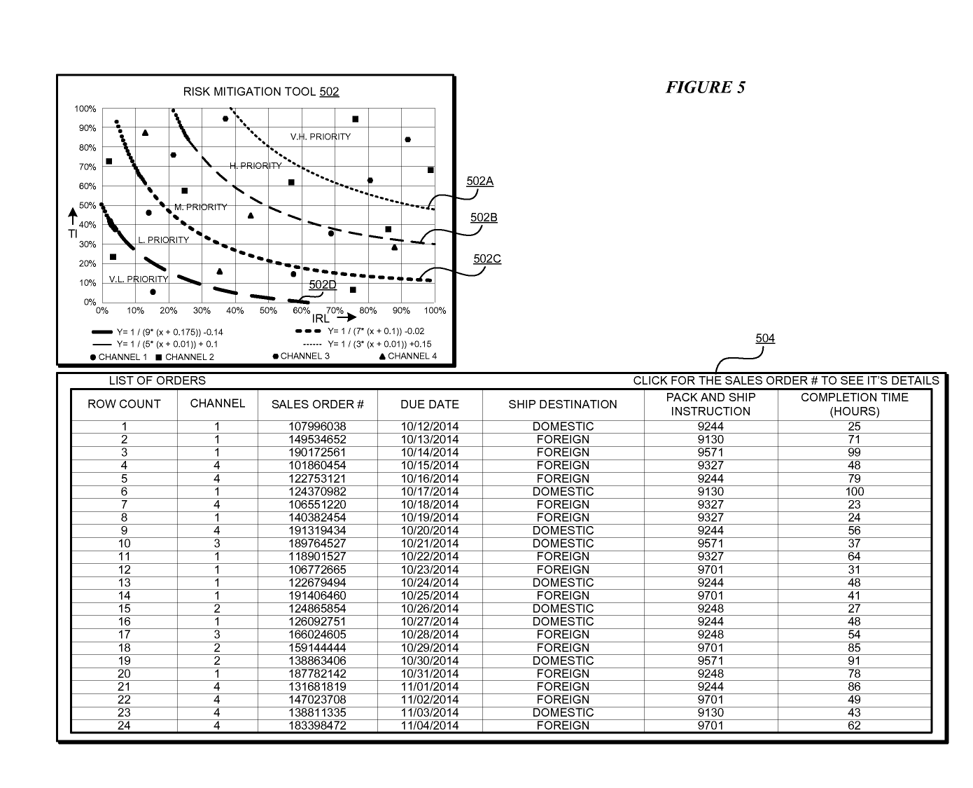

With reference to FIG. 5, this figure depicts an example user interface presentation of risk mitigation graph and list of orders with details in a shared shipping process in accordance with an illustrative embodiment. Graph 502 is an example of graph 402 in FIG. 4.

Table 504 shows the list of orders shown in graph 502 and awaiting shipping at the shared capacity constrained shipping dock during a given period. In the depicted example, twenty four example completed or in-progress orders are ranked according to their respective (IRL, TI) coordinates relative to one another and relative to the defined risk zones 502A, 502B, 502C, and 502D. Risk zones 502A-D in graph 502 are similar to risk zones 402A-D in graph 402 in FIG. 4. The orders are arranged in table 504 according to the ascending order of the due dates of the orders. Risk mitigation graph 502 is used as the deciding factor for shipment of the depicted example orders. The other columns in table 504 are populated with other order-related information available from system 107 in FIG. 1.

Graph 502 plots the example completed or in-progress orders from table 504 in the manner described with respect to FIGS. 3A and 4. Each plotted point in graph 502 represents the (IRL, TI) coordinates corresponding to a completed or in-progress order in table 504.

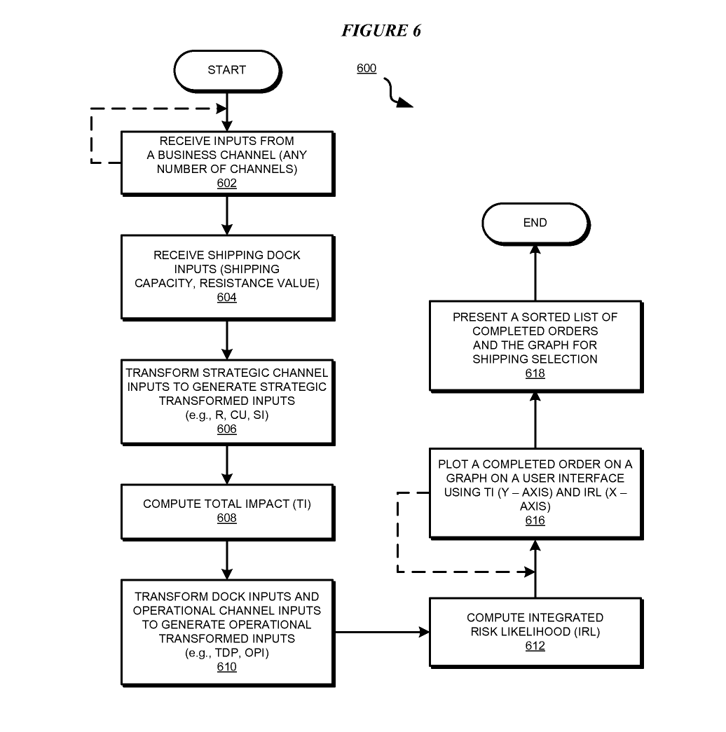

With reference to FIG. 6, this figure depicts a flowchart of an example process for risk mitigation in a shared shipping process in accordance with an illustrative embodiment. Process 600 can be implemented in risk mitigation tool 302 in FIG. 3A.

The tool receives a set of inputs corresponding to a completed or in-progress order from a business channel, e.g., inputs 304 in FIG. 3A (block 602). The tool receives any number of such sets of inputs corresponding to any number of completed or in-progress orders from any number of business channels. The tool receives shipping dock inputs for a period, e.g., inputs 312 in FIG. 3A (block 604).

The tool transforms the strategic inputs in the channel inputs from block 602, e.g., strategic inputs 304A, to form strategic transformed inputs, e.g., R, CU, and SI (block 606). The tool computes TI for the completed or in-progress order from the strategic transformed inputs of block 606 (block 608).

The tool transforms the operational inputs in the channel inputs from block 602, e.g., operational inputs 304B, to form operational transformed inputs, e.g., TDP and OPI (block 610). The tool computes IRL for the completed or in-progress order from the operational transformed inputs of block 610 (block 612).

The tool plots the (IRL, TI) coordinates of a completed or in-progress order on a graph on a user interface (block 616). The tool plots the (IRL, TI) coordinates of any number of completed or in-progress orders on the graph on the user interface in a similar manner. Note that the user interface can be a digital display device, a printout, or any other suitable visual medium.

The tool presents or outputs an ordered list of completed or in-progress orders, e.g., according to an ascending order of the due dates of the orders, and the graph on the user interface to a user (block 618). The tool ends process 600 thereafter.

In one embodiment, the user is a shipping application executing in a shipping system. The shipping system uses the outputted graph or various artifacts thereof, and the outputted list from block 618, to select the orders to ship. For example, the shipping system uses the graph attributes described herein to schedule an order from the list, whose risk exceeds the risk of another order in the list, for shipping using the shared shipping dock resource before scheduling the other order with the relatively lower risk. In one embodiment, the shipping system automatically ships the order selected by using the risk graph attributes in this manner.

The tool can repeat process 600 to process any number of completed or in-progress orders in this manner. The tool can repeat block 604 an number of times to receive the shipping dock inputs for different periods, or to receive updates to previously received shipping dock inputs.

Thus, a computer implemented method, system or apparatus, and computer program product are provided in the illustrative embodiments for risk mitigation in a shared shipping process for prioritized orders. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for shipping orders from various manufacturing channels using a shared shipping process, the method comprising:
receiving, from an order processing channel, a set of channel inputs corresponding to an order;
transforming, using a processor and a memory, and using a transformation rule, a strategic subset of the set of the channel inputs, forming a set of strategic transformed inputs;
computing a total impact value corresponding to the order;
computing an integrated risk likelihood value corresponding to the order;
outputting to a shipping system the integrated risk likelihood value and the total impact value of the order relative to a second integrated risk likelihood value and a second total impact value of a second order from a second order processing channel, as a comparison of a first risk associated with the order relative to a second risk associated with the second order at a shipping dock, wherein the shipping dock is shared by the order processing channel and the second order processing channel; and
shipping the order using the shipping system, wherein the order is shipped in response to the first risk being higher than the second risk.

2. The method of claim 1, wherein the set of strategic transformed inputs comprises:
a revenue score between 0 and 1 derived from a revenue generated from the order, a customer urgency score between 0 and 1 derived from a type of customer related to the order, and a sales impact score between 0 and 1 derived from a business channel that processed the order.

3. The method of claim 1, wherein the total impact value is a part of a coordinate corresponding to the order, wherein the coordinate is usable to plot the order relative to a risk zone identified on a graph.

4. The method of claim 1, wherein the integrated risk likelihood value is a part of a coordinate corresponding to the order, wherein the coordinate is usable to plot the order relative to a risk zone identified on a graph.

5. The method of claim 1, further comprising:
transforming, using another transformation rule, an operational subset of the set of the channel inputs, forming a set of operational transformed inputs; and
using, as a part of computing the integrated risk likelihood value, the set of operational transformed inputs.

6. The method of claim 5, wherein the set of operational transformed inputs comprises:
a transportation delay probability between 0 and 1 corresponding to the product and derived from (i) a transportation mode specified for shipping the order, (ii) a weather forecast expected during the shipping of the order, and (iii) a number of transit points during the shipping of the order.

7. The method of claim 5, wherein the set of operational transformed inputs comprises:
a priority index corresponding to the order and derived from (i) a shipping capacity of a shipping dock during a period, (ii) a variation in the shipping capacity during the period, and (iii) a rank of the order in the order processing channel.

8. A computer readable article of manufacture tangibly embodying computer readable instructions which, when executed, cause a computer to carry out steps of a method for shipping orders from various manufacturing channels using a shared shipping process, the method comprising:
receiving, from an order processing channel, a set of channel inputs corresponding to an order;
transforming, using a processor and a memory, and using a transformation rule, a strategic subset of the set of the channel inputs, forming a set of strategic transformed inputs;
computing a total impact value corresponding to the order;
computing an integrated risk likelihood value corresponding to the order;
outputting to a shipping system the integrated risk likelihood value and the total impact value of the order relative to a second integrated risk likelihood value and a second total impact value of a second order from a second order processing channel, as a comparison of a first risk associated with the order relative to a second risk associated with the second order at a shipping dock, wherein the shipping dock is shared by the order processing channel and the second order processing channel; and
shipping the order using the shipping system, wherein the order is shipped in response to the first risk being higher than the second risk.

9. The article of manufacture of claim 8, embodying instructions wherein the set of strategic transformed inputs comprises:
a revenue score between 0 and 1 derived from a revenue generated from the order, a customer urgency score between 0 and 1 derived from a type of customer related to the order, and a sales impact score between 0 and 1 derived from a business channel that processed the order.

10. The article of manufacture of claim 8, embodying instructions wherein the total impact value is a part of a coordinate corresponding to the order, wherein the coordinate is usable to plot the order relative to a risk zone identified on a graph.

11. The article of manufacture of claim 8, embodying instructions wherein the integrated risk likelihood value is a part of a coordinate corresponding to the order, wherein the coordinate is usable to plot the order relative to a risk zone identified on a graph.

12. The article of manufacture of claim 8, embodying instructions which, when executed, cause the computer to carry out the method further comprising:
transforming, using another transformation rule, an operational subset of the set of the channel inputs, forming a set of operational transformed inputs; and
using, as a part of computing the integrated risk likelihood value, the set of operational transformed inputs.

13. The article of manufacture of claim 12, embodying instructions wherein the set of operational transformed inputs comprises:
a transportation delay probability between 0 and 1 corresponding to the product and derived from (i) a transportation mode specified for shipping the order, (ii) a weather forecast expected during the shipping of the order, and (iii) a number of transit points during the shipping of the order.

14. The article of manufacture of claim 12, embodying instructions wherein the set of operational transformed inputs comprises:
a priority index corresponding to the order and derived from (i) a shipping capacity of a shipping dock during a period, (ii) a variation in the shipping capacity during the period, and (iii) a rank of the order in the order processing channel.

15. The article of manufacture of claim 13 further embodying transferring instructions which, when executed, cause the computer to carry out the method further comprising:
transferring over a network from a remote data processing system, the computer readable instructions; and
storing, responsive to the transferring, the computer readable instructions in a data processing system.

16. The article of manufacture of claim 13 further embodying downloading instructions which, when executed, cause the computer to carry out the method further comprising:
downloading, from a server data processing system where the computer usable instructions are stored, over a network to a remote data processing system, the computer readable instructions for use in a computer readable storage device associated with the remote data processing system.

17. A data processing system for shipping orders from various manufacturing channels using a shared shipping process, the data processing system comprising:
a storage device, wherein the storage device stores computer usable program code; and
a processor, wherein the processor executes the computer usable program code, and wherein the computer usable program code comprises:
computer usable code for receiving, from an order processing channel, a set of channel inputs corresponding to an order;
computer usable code for transforming, using a processor and a memory, and using a transformation rule, a strategic subset of the set of the channel inputs, forming a set of strategic transformed inputs;
computer usable code for computing a total impact value corresponding to the order;
computer usable code for computing an integrated risk likelihood value corresponding to the order;
computer usable code for outputting to a shipping system the integrated risk likelihood value and the total impact value of the order relative to a second integrated risk likelihood value and a second total impact value of a second order from a second order processing channel, as a comparison of a first risk associated with the order relative to a second risk associated with the second order at a shipping dock, wherein the shipping dock is shared by the order processing channel and the second order processing channel; and
computer usable code for shipping the order using the shipping system, wherein the order is shipped in response to the first risk being higher than the second risk.

18. The data processing system of claim 17, wherein the set of strategic transformed inputs comprises:
a revenue score between 0 and 1 derived from a revenue generated from the order, a customer urgency score between 0 and 1 derived from a type of customer related to the order, and a sales impact score between 0 and 1 derived from a business channel that processed the order.

19. The data processing system of claim 17, wherein the total impact value is a part of a coordinate corresponding to the order, wherein the coordinate is usable to plot the order relative to a risk zone identified on a graph.

20. The data processing system of claim 17, wherein the integrated risk likelihood value is a part of a coordinate corresponding to the order, wherein the coordinate is usable to plot the order relative to a risk zone identified on a graph.
